(19) United States
(12) Patent Application Publication
(10) Pub. No.: US 2019/0353042 A1
(43) Pub. Date: Nov. 21, 2019

(54) EXHAUST ENERGY RECOVERY SYSTEM

(71) Applicant: Energy Recovery Solutions, LLC, Mikado, MI (US)

(72) Inventor: Randall Keith West, Mikado, MI (US)

(21) Appl. No.: 16/413,990

(22) Filed: May 16, 2019

Related U.S. Application Data
(60) Provisional application No. 62/672,197, filed on May 16, 2018.

(51) Int. Cl. F01D 7/00; F01D 5/02; F01D 5/30; F01D 25/28

(52) U.S. Cl. CPC F01D 7/00; F01D 5/021; F01D 5/303; F05D 2240/242; F05D 2220/324; F05D 2220/64; F05D 2220/76; F01D 25/28

(57) ABSTRACT

An exhaust air energy recovery system configured for efficiently extracting energy from an exhaust stack of a building, duct, mine, server, or the like. The system includes an exhaust stack through which exhaust air moves and a turbine assembly connected to the exhaust stack by one or more legs. The turbine assembly is configured to generate energy from the exhaust air, and the turbine assembly includes a generator configured to convert energy based on the exhaust air; a turbine rotor connected to the generator; and a hub portion interposed between the generator and the lower blade plate.

### PRIORITY CLAIM

This patent application claims priority to and the benefit of the filing date of provisional patent application having Application No. 62/672,197, filed on May 16, 2018, which is incorporated herein by reference.

### FIELD

The present disclosure relates to an exhaust air energy recovery system for reusing exhaust air and natural wind energy to generate electricity.

### BACKGROUND

Wind/air turbines convert kinetic energy from air into mechanical torque by creating a lift force when air flows past blades of the turbine. The lift force creates torque that can rotate a shaft to which the blades are attached. By coupling an electrical generator with the turbines, energy may be extracted from air flow to product electrical energy. Many conventional wind turbines use blades with variable blade pitch to maximize energy extraction from the wind by adjusting the blade pitch based on the velocity of the wind. However, these turbines are often very expensive and prone to failure.

Air turbines can also be used to extract energy from waste air exhausts of buildings, ducts, mines, furnaces, servers, and the like. However, most of the existing systems that produce electrical energy from exhaust air are inefficient at extracting energy from moving air. Some systems require activation of an air compressor and/or an air motor to drive a generator. As such, additional energy is used to pressurize the exhausted air. Other systems require a large number of conventional turbine blades having the same pitch. Such blades are often inefficient at transferring air flow into torque, which significantly limits overall efficiency.

Accordingly, there exists a need for an exhaust energy recovery system to capture maximum exhaust air flow in order to generate a sufficiently large amount of electricity and/or mechanical power.

### SUMMARY

In an embodiment, an exhaust air energy recovery system configured for efficiently extracting energy from an exhaust stack of a building, duct, mine, server, or the like. The system includes an exhaust stack through which exhaust air moves and a turbine assembly connected to the exhaust stack by one or more legs. The turbine assembly is configured to generate energy from the exhaust air, and the turbine assembly includes a generator configured to convert energy based on the exhaust air; a turbine rotor connected to the generator; and a hub portion interposed between the generator and the lower blade plate. The turbine rotor is configured to be rotated and includes an upper blade plate selectively connected to an opposing lower blade plate; a plurality of adjustable blades extending radially outward from the upper blade plate; a plurality of moveable portions configured to change the pitch angles of the adjustable blades, wherein each of the moveable portions have a first end and a second end, and wherein the first end of each of the moveable portions is selectively attached to an upper surface of the upper blade plate and the second end of each of the moveable portions is selectively interlocked with at least a portion of one of the adjustable blades.

In some embodiments, each of the moveable portions is equidistant from a center portion on the upper blade plate and each of the moveable portions include an opening across the outer diameter of the second where, wherein the adjustable blades are selectively interlocked in the openings on the second end of the moveable portions.

### BRIEF DESCRIPTION OF THE DRAWINGS

The above, as well as other advantages of the present disclosure, will become readily apparent to those skilled in the art from the following detailed description when considered in light of the accompanying drawing in which:

FIG. 1 is a schematic perspective view of an energy recovery system according to an embodiment of the disclosure;

FIG. 2 is a schematic top perspective view of a portion of the energy recovery system illustrated in FIG. 1;

FIG. 3 is a schematic top plan view of the portion of the energy recovery system illustrated in FIGS. 1 and 2;

FIG. 4 is a schematic bottom plan view of the portion of the energy recovery system illustrated in FIGS. 1-3;

FIG. 5 is a schematic side view of the portion of the energy recovery system illustrated FIGS. 1-4;

FIG. 6 is a schematic sectional view of the portion of the energy recovery system illustrated in FIGS. 1-5;

FIG. 7 is a schematic exploded view of the portion of the energy recovery system illustrated in FIGS. 1-6;

FIG. 8 is a schematic perspective view of a portion of the energy recovery system illustrated in FIG. 7;

FIG. 9 is a schematic view of a blade of the energy recovery system illustrated in FIGS. 1-5 and 7; and

FIG. 10 is a schematic perspective view of a portion of the energy recovery system illustrated in FIGS. 1-3 and 7.

### DETAILED DESCRIPTION

In is to be understood that the invention may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

Disclosed herein is an energy recovery generator system for capturing exhaust air flow and natural wind energy to generate electricity and/or mechanical power. The energy recovery system is configured to efficiently extract energy from various sources, such as a building exhaust, a duct exhaust, a mine exhaust, and the like.

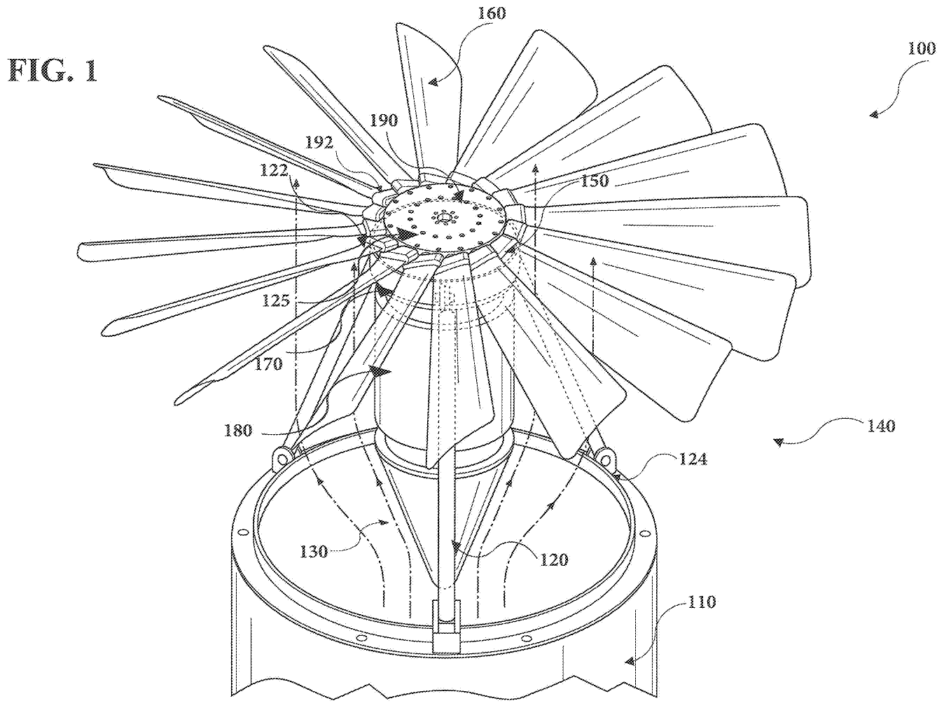

Referring to FIG. 1, FIG. 1 shows a schematic perspective view of an energy recovery system 100 according to an embodiment of the disclosure. The energy recovery system 100 includes a turbine assembly 140 configured to generate electrical and/or mechanical energy from exhaust air flow. In this embodiment, the turbine assembly 140 includes a turbine rotor 150 connected to an energy recover generator 180.

The turbine rotor 150 may have a plurality of adjustable blades 160 and a hub portion 170 that connects the turbine rotor 150 with the energy recovery generator 180. The adjustable blades 160 extend radially outward from an upper blade plate 190. The upper blade plate 190 may have a plurality of spaced apertures 125 for entraining air in a vortex for better plume dispersal/distance from sources of exhaust flow, such as buildings. In some examples, the upper blade plate 190 has an outer diameter of between about 7 and 20 inches.

In an embodiment, the energy recovery generator 180 is an electrical generator configured to convert kinetic energy caused by movement of the turbine rotor 150 into electrical or mechanical energy. In a non-limiting example, the energy recovery generator 180 is an axial flux permanent magnet generator. However, one of ordinary skill in the art would understand that the energy recovery generator 180 may be other types of generators.

In some embodiments, the outer diameter of the energy recovery generator 180 is between about 6 and 16 inches in order to reduce airflow restriction throughout the system 100. In the embodiment illustrated in FIG. 1, the energy recovery generator 180 is vertically-stacked in the energy recovery system 100. One of ordinary skill in the art would understand that the energy recovery generator 180 may be positioned and oriented in other positions within the energy recovery system 100

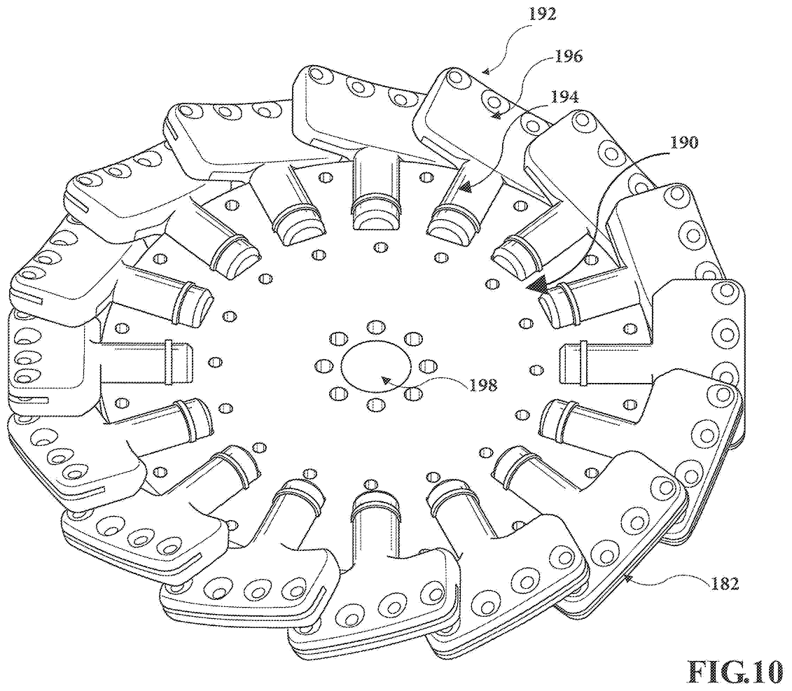

In an embodiment, the turbine rotor 150 further includes a plurality of moveable portions 192 selectively attached to a surface of the upper blade plate 190. As best shown in FIG. 10, a first end 194 on each of the moveable portions 192 may be attached to the surface of the upper blade plate 190 and extend to an outer end of the upper blade plate 190 such that a second end 196 on each of the moveable portions 192 is disposed around the outer perimeter of the upper blade plate 190. In some examples, each of the moveable portions 192 is equidistant from a center portion 198 of the upper blade plate 190.

As best shown in FIG. 10, the second end 196 on each of the moveable portions 192 may be selectively coupled to at least a portion of each of the plurality of adjustable blades 160. The second end 196 on each of the moveable portions 192 may include an opening 182 extending across the outer diameter of the second end 196. A portion of the adjustable blades 160 may be inserted into the openings 182 to interlock the adjustable blades 160 with the moveable portions 192. The moveable portions 192 are configured to secure the adjustable blades 160 in place when the adjustable blades 160 are connected. The adjustable blades 160 may also be readily disconnected from the moveable portions 192.

In the embodiment shown in FIG. 10, the turbine rotor 150 includes 16 adjustable blades 160 and 16 moveable portions 192. However, one of ordinary skill in the art would understand that the turbine rotor 150 may include either less than 16 adjustable blades 160 and 16 moveable portions 192 or more than 16 adjustable blades 160 and 16 moveable portions 192.

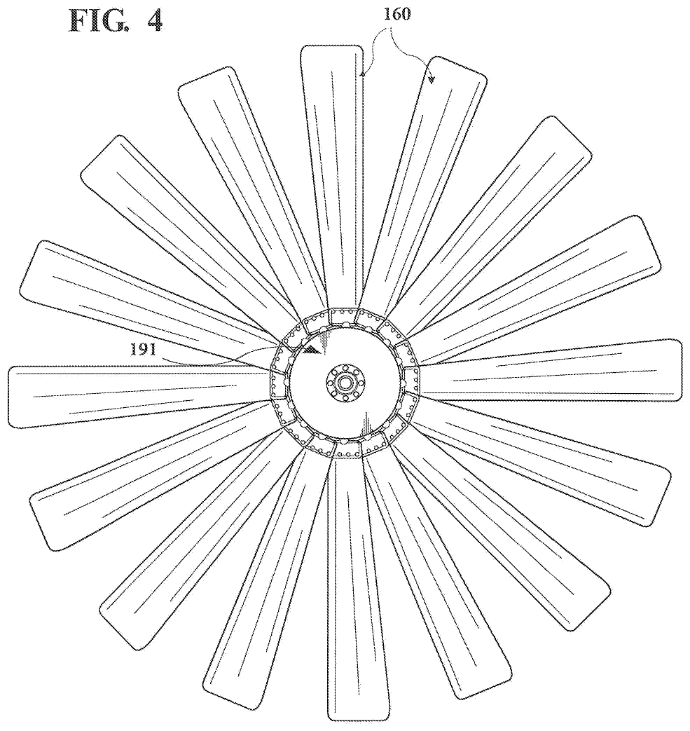

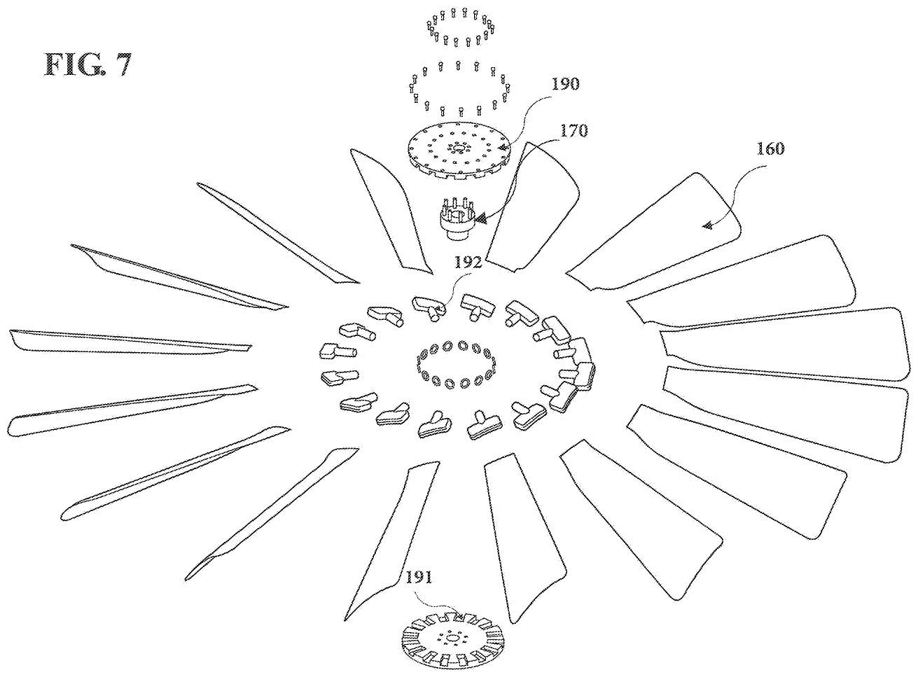

As best shown in FIGS. 4 and 7, the turbine assembly 140 also includes a lower blade plate 191. The lower blade plate 191 may have a plurality of spaced apertures 135 entraining air in a vortex for better plume dispersal/distance from sources of exhaust flow, such as buildings. In some examples, the lower blade plate 191 has an outer diameter of between about 7 and 20 inches. The lower blade plate 191 may be selectively connected to the upper blade plate 190 via various means, such as injection molding.

As best shown in FIG. 1, one or more legs 120 aid in supporting and positioning the turbine assembly 140 on an exhaust stack 110. The turbine assembly 140 is configured for receiving an exhaust flow of air (e.g. exhaust flow 130) in a generally vertical direction. The one or more legs 120 allow the turbine assembly 140 to be connected to various types of surfaces at various orientations. In the embodiment illustrated in FIG. 1, the legs 120 aid in positioning the turbine assembly 140 at a predetermined distance away from the top of the exhaust stack 110 to limit any static pressure on the system 100 and avoid restrictions of airflow from the exhaust stack 110. Due to the positioning of the turbine assembly 140 with respect to the exhaust stack 110, the system 100 is able to capture the optimum velocity of exhaust flow 130 and generate large amounts of electricity.

The exhaust flow 130 may proceed from the exhaust stack 110 to the turbine rotor 150. The rotation of the turbine rotor 150 can then be directly transferred to the energy recovery generator 180 without any additional equipment.

In some embodiments, three telescopically-adjustable legs 120 are each attached at a first end 122 to a portion of the turbine assembly 140 and at a second end 124 to a portion of the exhaust stack 110. In an embodiment, the turbine assembly 140 is spaced from the top of the exhaust stack 110 at a distance of about 1.5 times the outer diameter of the exhaust stack 110. One of ordinary skill in the art would understand that there may be more or less than three legs 120 in various orientations.

The exhaust flow 130 may be provided by an air conditioning, a heating, or a ventilation system. The exhaust flow 130 may also come from the exhaust stack 110, which may be horizontal, vertical, or at another angle relative to the ground. The exhaust flow 130 is the air discharged from any system or the exhaust stack 110 where the exhausted air is not being put to any applicable usage. Generally, the exhaust flow 130 is characterized by constant or near constant velocity.

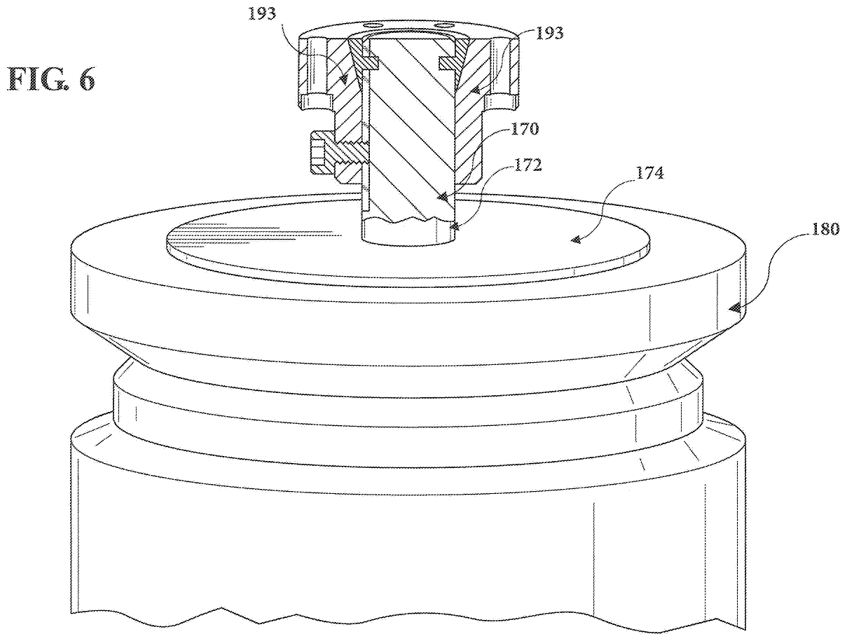

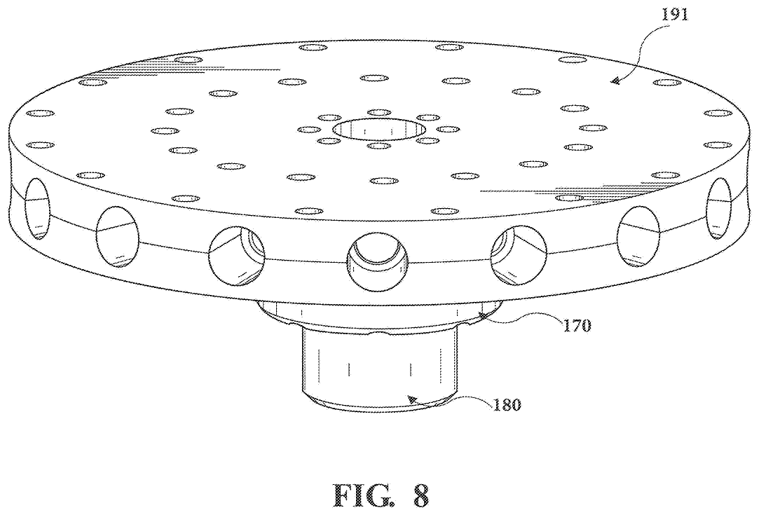

As best shown in FIGS. 6-8, the hub portion 170 may be interposed between the lower blade plate 191 and the energy recovery generator 180. In some embodiments, a first segment 172 of the hub portion 170 may have a conical shape for better air deflection below the turbine rotor 150 and for improved thrust of the adjustable blades 160. The first segment 172 is connected to a second segment 174, wherein the second segment 174 is substantially circular and has a larger outer diameter than the first segment 172. The second segment 174 is configured for attachment to the energy recovery generator 180. In an embodiment, the hub portion 170 is injection molded to the bottom blade pate 191 and is made of any suitable materials, such as, plastic, resin, steel, and any combinations thereof.

As best shown in FIG. 6, the hub portion 170 also includes one or more wedges 193. In some embodiments, the hub portion 170 includes a pair of opposing wedges 193 in order to aid stability to the hub portion 170.

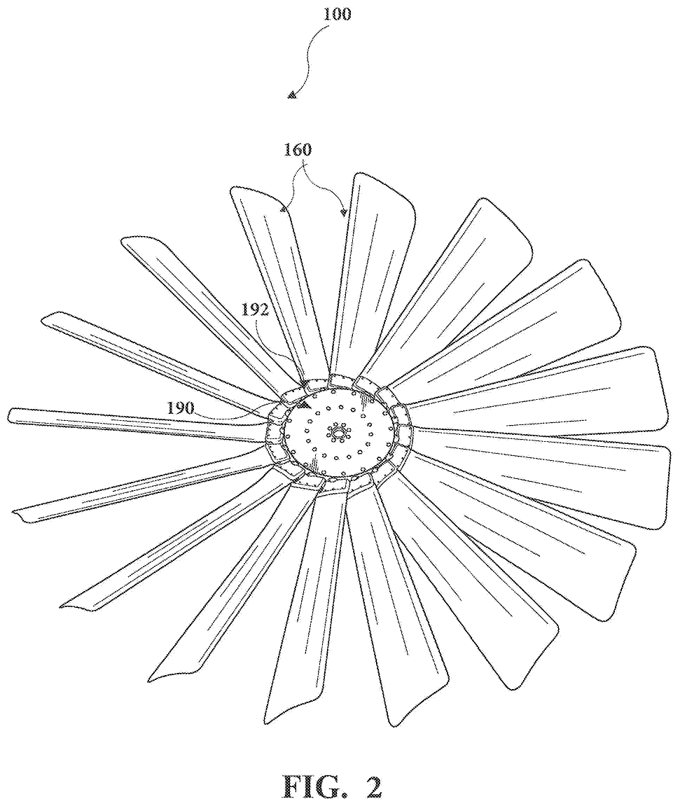

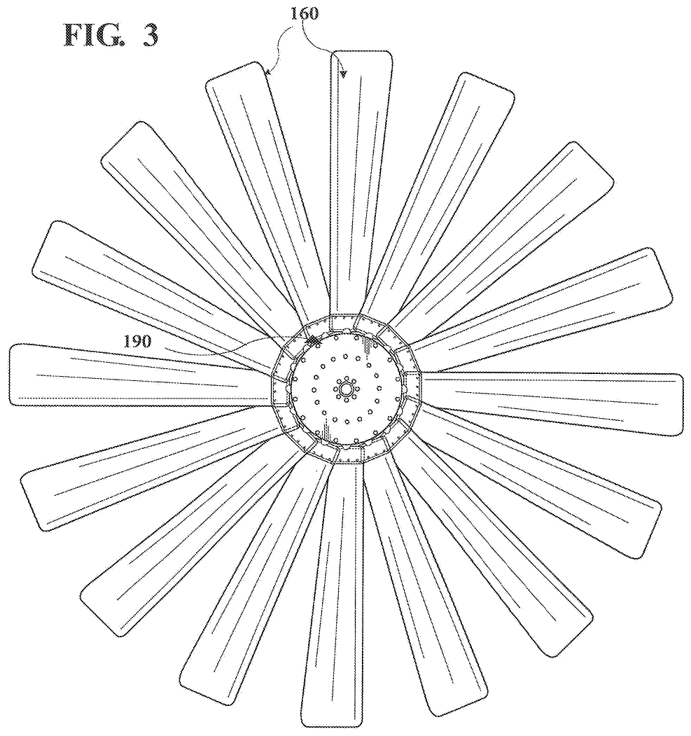

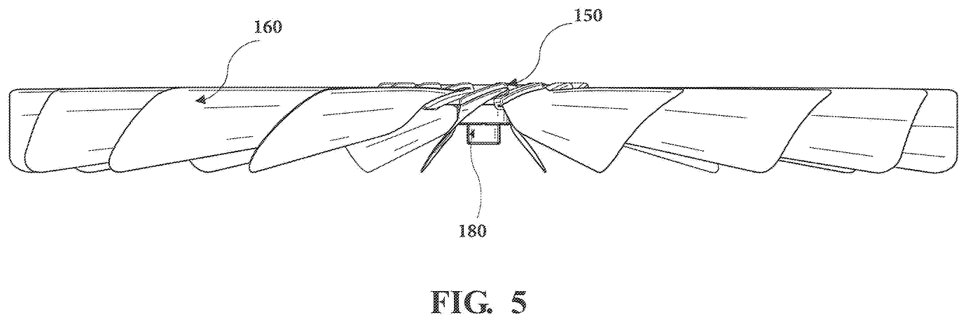

Referring to FIGS. 2-5, FIGS. 2-5 show views of the adjustable blades 160 of the energy recovery system 100. The turbine rotor 150 and the adjustable blades 160 are configured to rotate horizontally about a vertical axis. As such, the turbine rotor 150 and the adjustable blades 160 rotate in a substantially perpendicular orientation to the exhaust flow 130.

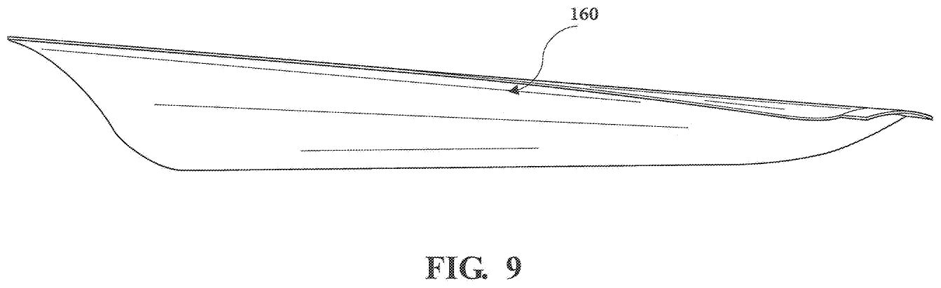

As best shown in FIG. 9, each of the adjustable blades 160 may be generally airfoil-shaped. In other embodiments, though, the adjustable blades 160 may have different configurations/shapes. In some embodiments, the pitch angles of the adjustable blades 160 is varied, while in other embodiments, the pitch angles of the adjustable blades 160 is fixed. By varying the pitch angles of the adjustable blades 160.

The pitch angle of the adjustable blades 160 is affected by the upper blade plate 190 and the lower blade plate 191. The pitch angles of the adjustable blades 160 may be varied via the moveable portions 192. In some examples, the pitch angles of the adjustable blades 160 may vary between about 0 and 50 degrees and in some examples, the pitch angle of the adjustable blades 160 between about 40 and 50 degrees. By varying the pitch angles of the adjustable blades 160 as disclosed herein, there is much greater efficiency in conversion of the kinetic energy of the incoming exhaust flow. In some embodiments, the adjustable blades 160 can rotate at about 500 revolutions/minutes.

Electricity generated by the energy recovery system 100 disclosed herein may be used to reduce the electrical power requirements of operating current air conditioning, heating, and ventilation systems.

The figures provided herein are merely representational and may not be drawn to scale. Certain proportions thereof may be exaggerated, while others may be minimized. Accordingly, the specification and drawings are to be regarded in an illustrative rather than a restrictive sense. It will, of course, be understood that, although particular embodiments have just been described, the claimed subject matter is not limited in scope to a particular embodiment or implementation. Likewise, an embodiment may be implemented in any combination of systems, methods, or products made by a process, for example.

In the preceding description, various aspects of claimed subject have been described. For purposes of explanation, specific numbers, systems, and/or configurations were set forth to provide a thorough understanding of claimed subject matter. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter.

What is claimed is:

1. An exhaust air energy recovery system comprising:
an exhaust stack through which exhaust air moves;
a turbine assembly connected to the exhaust stack by one or more legs, wherein the turbine assembly is configured to generate energy from the exhaust air, and wherein the turbine assembly comprises:
a generator configured to convert energy based on the exhaust air;
a turbine rotor connected to the generator, wherein the turbine rotor is configured to be rotated and the turbine rotor comprises:
an upper blade plate selectively connected to an opposing lower blade plate;
a plurality of adjustable blades extending radially outward from the upper blade plate;
a plurality of moveable portions configured to change the pitch angles of the adjustable blades, wherein each of the moveable portions have a first end and a second end, wherein the first end of each of the moveable portions is selectively attached to an upper surface of the upper blade plate and the second end of each of the moveable portions is selectively interlocked with at least a portion of one of the adjustable blades; and
a hub portion interposed between the generator and the lower blade plate.

2. The system of claim 1, wherein each of the moveable portions is equidistant from a center portion on the upper blade plate.

3. The system of claim 1, wherein each of the moveable portions include an opening across the outer diameter of the second where, wherein the adjustable blades are selectively interlocked in the openings on the second end of the moveable portions.

4. The system of claim 1, wherein the legs are telescopically-adjustable.

5. The system of claim 1, wherein each of the upper blade plate and the lower blade plate includes a plurality of apertures configured for entraining the exhaust air.

6. The system of claim 1, wherein the hub portion includes one or more wedges configured to stabilize the hub portion.

7. The system of claim 1, wherein the hub portion includes a substantially conical first segment and a substantially circular second segment, wherein the diameter of the second segment is larger than the diameter of the first segment.
